(19) United States
(12) Patent Application Publication
(10) Pub. No.: US 2009/0210740 A1
(43) Pub. Date: Aug. 20, 2009

(54) OFF-CHIP ACCESS WORKLOAD CHARACTERIZATION METHODOLOGY FOR OPTIMIZING COMPUTING EFFICIENCY

(76) Inventors: Song HUANG, Blacksburg, VA (US); Wu-chun Feng, Blacksburg, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/372,286

(22) Filed: Feb. 17, 2009

Related U.S. Application Data
(60) Provisional application No. 61/028,727, filed on Feb. 14, 2008.

(51) Int. Cl. G06F 1/04

(52) U.S. Cl. 713/502

(57) ABSTRACT

A system, apparatus, and method are provided which allows for reducing power consumption in dynamic voltage and frequency scaled processors while maintaining performance within specified limits. The method includes determining the off-chip stall cycle in a processor for a specified interval in order to characterize a frequency independent application workload in the processor. This current application workload is then used to predict the application workload in the next interval which is in turn used, in conjunction with a specified performance bound, to compute and schedule a desired frequency and voltage to minimize energy consumption within the performance bound. The apparatus combines the aforementioned method within a larger-scale context that reduces the energy consumption of any given computing system that exports a dynamic voltage and frequency scaling interface. The combination of the apparatus and method form the overall system.

### CROSS-REFERENCE TO RELATED APPLICATIONS

This application claims priority to U.S. Provisional Application Ser. No. 61/028,727 filed Feb. 14, 2008. The complete contents of that application is herein incorporated by reference.

### BACKGROUND OF THE INVENTION

1. Field of the Invention

This invention pertains generally to reducing power consumption in any computing environment (e.g., embedded computing system, laptop, datacenter server, supercomputer), and more particularly to a system, apparatus, and method for implementing a power- and energy-aware environment and algorithm that automatically and transparently adapts processor voltage and frequency settings to achieve significant power and energy reduction with minimal impact on performance.

2. Background Description

The total electricity bill to operate datacenter servers and related infrastructure equipments is estimated to have more than doubled in the United States and worldwide between 2000 and 2005, to $7.2 billion worldwide ($2.7 billion U.S.). Additionally, the high power density of these systems undermines both their availability and reliability.

Different approaches to improve the energy and power efficiency of computers focus on different levels of abstraction: hardware, systems integration, systems software, middleware, and applications software. One of the systems-level approaches leverages a mechanism called Dynamic Voltage and Frequency Scaling (DVFS) to decrease the voltage and frequency of a DVFS-enabled processor in order to minimize power consumption when it is not doing useful work. However, given that the time to scale voltage and frequency takes on the order of 10,000,000 clock cycles, sophisticated use of DVFS is needed if energy reduction is to be realized within a performance bound.

The past few years have seen significant research in power-aware computing, which can be broadly categorized along a multitude of dimensions: off-line vs. on-line; trace-based or profile-based scheduling vs. model-based scheduling; and static vs. dynamic. The on-line method can achieve better accuracy than off-line methods and has advantages for system-wide scheduling required for emerging multi-core and many-core environments where a computing system can run one or multiple applications simultaneously.

Lim (see Lim, M. Y., et al., Adaptive transparent frequency and voltage scaling of communication phases in MNPI programs. In Proceedings of the ACM/IEEE Supercomputing 2006 (SC06), 2006) designed an on-line system that dynamically reduces processor performance during communication phases in Message Passing Interface (MPI) programs. Curtis-Maury (M. Curtis-Maury, M., et al., Online power-performance adaptation of multithreaded programs using hardware event-based prediction. In International Conference on Supercomputing (ICS06), Queensland, Australia, June 2006.) presented a comprehensive framework for autonomic power-performance adaptation of multi-threaded programs using thread throttling. However, since the above are designed for MPI and OpenMP applications, respectively, they have limited application. For power-aware techniques using general workload characterization, Choi and Pedram (Choi, R. and M. Pedram, M., Fine-grained dynamic voltage and frequency scaling for precise energy and performance trade-off based on the ratio of off-chip access to onchip computation times. IEEE transactions on computer-aided design of integrated circuits and systems, 24(1), 2005.), Hsu and Feng (Hsu, C. and Feng, W., A power-aware run-time system for high-performance computing. In Proceedings of the ACM/IEEE Supercomputing 2005 (SC05), 2005.) (β algorithm), and Ge (Ge, R., et al., CPU MISER: A performance-directed, run-time system for power-aware clusters. In International Conference on Parallel Processing, 2007 (ICPP07), 2007.) have established the current state-of-the-art for general computing systems.

Choi and Pedram proposed a DVFS approach based on the ratio of off-chip access to on-chip computation time that targeted embedded systems. It uses the number of instructions and external memory accesses to compute the ratio of off-chip computation time to on-chip computation time. However, this has limitations since off-chip access time is processor-frequency independent, while on-chip computation time decreases with increased processor frequency. Moreover, this method only considers memory access and ignores thread synchronization in exploring energy-saving opportunities.

The β algorithm of Hsu and Feng assumes that processor boundedness is indirectly reflected via the MIPS (millions of instructions per second) rate. Since the MIPS rate only approximately reflects processor boundedness and is dependent on processor frequency, it cannot accurately characterize application workload nor can it effectively bound performance loss. Another drawback to the β algorithm is that it is insensitive to workload variation. This compromises the accuracy of its workload characterization and misses potential energy savings.

CPU MISER of Ge et al. relies on cache-access statistics to provide information about the workload. It also assumes the number of instructions executed approximates the number of on-chip accesses based on heuristics. As such, this approach only accurately characterizes workload on average.

The Linux on-demand governor is the most widely employed across laptops, desktops and servers. This method is provided in the CPUFreq subsystem of a recent Linux kernel. It dynamically changes CPU (i.e., processor) frequency depending on CPU utilization. Because CPU utilization is misleading in terms of characterizing a program's workload, this approach cannot efficiently deliver both power savings while controlling performance loss.

There are significant opportunities to improve workload characterization in order to reduce power consumption in DVFS-enabled processors while maintaining overall performance within specified bounds. This is particularly true for environments with dynamic and variable workloads, for system-wide monitoring and control of multiple processors (cores), and where highly configurable and transplantable solutions are required.

### SUMMARY OF THE INVENTION

According to the invention, a system, apparatus, and method are provided which allows for reducing power consumption in dynamic voltage and frequency scaled processors while maintaining performance within specified limits. The method includes determining the off-chip stall cycle in a processor for a specified interval in order to characterize a frequency independent application workload in the processor. This current application workload is then used to predict the application workload in the next interval which is in turn used, in conjunction with a specified performance bound, to compute and schedule a desired frequency and voltage to minimize energy consumption within the performance bound.

### BRIEF DESCRIPTION OF THE DRAWINGS

The present invention will be understood and appreciated more fully from the following detailed description in conjunction with the drawings in which:

FIG. 1 illustrates the implementation of the methodology with respect to hardware cores;

FIG. 2 illustrates the effectiveness of an implementation of the present invention in characterizing workload with respect to an alternative off-line method;

FIG. 3 illustrates the performance of an implementation of the present invention under different performance bounds;

FIG. 4 illustrates the energy savings of an implementation of the present invention for various performance bounds;

FIG. 5 illustrates the performance control of an implementation of the present invention in comparison to prior art implementations;

FIG. 6 illustrates the CPU energy savings of an implementation of the present invention in comparison to prior art implementations; and

FIG. 7 illustrates overall energy savings of an implementation of the present invention in comparison to prior art implementations.

### DETAILED DESCRIPTION

From a power-aware perspective, the behavior of an application can create opportunities for energy savings. Execution phases with memory-intensive activities have been an attractive target for DVFS algorithms because the time for a memory access is independent of how fast the processor is running. When frequent memory or input/output (I/O) accesses dominate a program's execution time, they limit how fast the program can finish executing. It is this memory wall that provides an opportunity to reduce power and energy consumption while maintaining performance. In cluster computing and grid environments, there are further opportunities for power and energy savings, particularly network or I/O operation as well as network process synchronization as well as I/O synchronization, e.g., traditional collective I/O. During the operation or synchronization, CPUs are either waiting or idling.

### I—Theoretical Foundation

In Section A below, we review the theory of how to best control performance and how to derive a parameter λ to characterize application workloads, i.e., quantify application behavior. In Section B, we then present our methodology on how to measure λ using CPU stall cycles due to off-chip activities.

A. Workload Characterization

At the systems level, any execution time of a program at CPU frequency f can be divided into two parts. One part is frequency sensitive, and the other is frequency insensitive. Correspondingly, we divide the CPU execution cycles into on-chip cycles Cₒₙ and off-chip cycles C_{off}.

Cₒₙ+C_{off}=T(f)·f (1)

Cₒₙ is the CPU cycles whose execution is affected by frequency variation while C_{off} is the CPU cycles whose execution is not affected by frequency variation.

We define T_{off} to represent the execution time that is CPU frequency insensitive.

$$T ( f ) = {C}_{on} \cdot \frac{1}{f} + {T}_{off} \qquad ( 2 )$$

When a program runs at maximum frequency fₘₐₓ,

$$T ( {f}_{max} ) = {C}_{on} \cdot \frac{1}{{f}_{max}} + {T}_{off} \qquad ( 3 )$$

T_{off} in Eq. (3) is the same as in Eq. (2) when executing the same amount of program instructions since T_{off} is not affected by the change of CPU frequency f.

To quantify the performance loss, we define a parameter δ that indicates the performance bound in employing DVFS,

$$\frac{T ( f ) - T ( {f}_{max} )}{T ( {f}_{max} )} < δ \qquad ( 4 )$$

Substituting T(f) and T(fmax) from Eq. (2) and (3), respectively, into Eq. (4), we get

$$\frac{{C}_{on}}{{C}_{on} + {T}_{off} \cdot {f}_{max}} \cdot \frac{{f}_{max} - f}{f} < δ$$

The equation can be reformulated as

$$λ \cdot \frac{{f}_{max} - f}{f} < δ \qquad ( 5 )$$

where

$$λ = \frac{{C}_{on}}{{C}_{on} + {T}_{off} \cdot {f}_{max}} \qquad ( 6 )$$

The workload characterization, denoted by λ in Eq. (6), can be reformulated as

$$λ = \frac{{C}_{on}}{{C}_{on} + {C}_{off} \cdot \frac{{f}_{max}}{f}} \qquad ( 7 )$$

Combining Eq. (1) and (7), we obtain

$$λ = \frac{{f}^{2} T ( f ) - {fC}_{off}}{{f}^{2} T ( f ) - {fC}_{off} + {f}_{max} {C}_{off}} \qquad ( 8 )$$

where 0≦λ≦1. The value of λ serves two purposes:
Intrinsic workload characterization. From Eq. (6), the workload characterization λ is a parameter that is independent of the CPU frequency at which the application is running. λonly depends on the application itself. Eq. (7) shows that λ characterizes the percentage of on-chip cycles out of the total CPU cycles at frequency fₘₐₓ. When λ equals to 1, C_{off} is 0, which means that the program spent all its time on on-chip activities. When λ equals 0, Cₒₙ must be 0, which means the program spent all its time on off-chip activities. Eq. (8) gives us a method to quantify the behavior of applications, even if they are not running on frequency fₘₐₓ.
Frequency schedule indicator. In Eq. (5), assuming the required performance constraint δ is constant, running at frequency f is a decreasing function of λ. The larger the λ, the more opportunities that exist for saving energy within the performance constraint. So, λ can direct us to schedule the appropriate frequency for a given workload.

B. Methodology for Measuring CPU Off-Chip Stall Cycles

In this section, we present our novel methodology for measuring SC_{off}. In order to achieve the desired accuracy, we obtain the CPU stall cycles due to off-chip activities from two aspects: on-chip (SC_{off}^{on}) and off-chip (SC_{off}^{off}).

1) Measuring from the On-Chip Perspective:

SC_{off}^{on}=SCₜₒₜₐₗ−SCₒₙ≃SCₜₒₜₐₗ−SC_{branch}−SC_{reorder}

where SC_{off}^{on} is the on-chip measurement of CPU stall cycles due to off-chip activities. For our methodology, we measure SCₜₒₜₐₗ using the CPU's decoder/dispatch stall cycles and measure SCₒₙ using the sum of the CPU's decoder stall cycles due to branch misprediction (SC_{branch}) and full reorder buffer (SC_{reorder}). These two events are chosen because they dominate CPU stall cycles due to on-chip activities and hardly overlap with each other. There are also other stall cycles contributors such as segment load and serialization, however, our empirical results show that CPU stall cycles contributed by these events are small; thus, we ignore them in our estimation.

2) Off-Chip Measurement:

SC_{off}^{off}=Nₘₑₘ·τₘₑₘ·f+Tᵢₒ·f+T_{idle}·f

where SC_{off}^{off} is the off-chip measurement of CPU stall cycles due to off-chip activities. Nₘₑₙ is the number of off-chip memory accesses; τₘₑₘ is the memory-access latency; Tᵢₒ is the CPU stall time for waiting on I/O completion; and T_{idle} is the CPU idle time. We use L2 cache misses to emulate the number of off-chip memory accesses and use LMBench [10] to measure the memory-access latency τₘₑₘ. Tᵢₒ and T_{idle} can be obtained through/proc/stat on Linux systems.

3) Synthetic Measurement:

We obtain our final measurement by taking the minimum of on-chip and off-chip measurement of CPU stall cycles due to off-chip activities.

SC_{off}=min(SC_{off}^{on},SC_{off}^{off})

The minimum is used since both measurements over-estimate the number of CPU stall cycles. On the one hand, for on-chip measurement, many events can cause CPU stalls, e.g. branch abortion, serialization, full reorder buffer, but there is no such hardware event that can measure CPU stall cycles due to off-chip activities directly. Moreover, most of the events involve both on-chip activities and off-chip activities. Therefore, an event cannot be simply treated as an event due to on-chip activities or off-chip activities. To exacerbate the problem, the events sometimes overlap with each other. On the other hand, off-chip measurement is also not accurate enough.

Let us take CPU stall cycles due to off-chip memory accesses as an example. Both off-chip memory accesses and memory latency are hard to determine precisely. The L2 cache misses measured by the hardware counter usually include some due to speculative execution. Additionally, due to CPU prefetching and block transfer, some L2 cache misses will be combined and transferred together. Thus, it is not exactly accurate to measure off-chip memory accesses using L2 cache misses. The actual number of memory accesses will be smaller than the measured value.

Two facts lead us to combine on-chip and off-chip measurements. For CPU-bound applications, L2 cache misses are smaller and the opportunity for combining and overlapping cache misses is small. Thus, off-chip measurement works better for CPU-bound applications. For non-CPU-bound applications, however, CPU stall cycles due to off-chip activities dominate the total CPU stall cycles. Therefore, on-chip measurement fits non-CPU-bound applications well.

### II—ECO Algorithm for a Power-Aware Run-Time System

Based on the theoretical foundation above, we developed a new workload-aware, eco-friendly algorithm called eco. The algorithm consists of multiple components: (1) the high-level algorithm itself that periodically determines whether to scale the frequency and voltage, (2) workload prediction to enable the decision of what to scale the frequency (and voltage) to, and (3) once a frequency is determined, how to schedule and emulate the frequency (and voltage) if the platform does not explicitly support the frequency. We refer to our power-aware, eco-friendly algorithm as eco and its implementation as ecod. The ecod system manages application performance and power consumption in real time based on an accurate measurement of CPU stall cycles due to off-chip activities and does not require application-specific information a priori.

A. Overview of Algorithm

The eco algorithm is an interval-based, run-time algorithm, whose execution time is divided into intervals that span the running time of an application program. Within each interval, the algorithm performs the following:

1) Characterizes the workload for the current interval, as noted in Section I. As stated before, frequent memory and I/O access, network process synchronization, as well as CPU idling constitute the three main opportunities for power-aware computing. However, these three opportunities vary from application to application and change from time to time. In short, the eco algorithm quantifies the application behavior at run time for each interval.

2) Predicts the workload characterization for the next interval. The eco algorithm predicts the workload for the next interval based on that of previous intervals. It uses the average of a λ window of previous intervals to predict the workload, since we observe that workload tends to be constant for short periods of time.

3) Schedules the frequency for the next interval. The eco algorithm schedules the CPU frequency based on the predicted workload characterization in order to maintain the performance bound while saving as much energy as possible. However, we must address two problems in frequency scheduling for real systems in this step: (1) CPUs only support discrete frequencies, and (2) CPU frequencies have a lower and upper bound.

B. Workload Prediction

Though workloads may vary from application to application, the workloads can still be predictable at some level. For example, we set a window size of L and use the average across the window to predict the λm current interval. The window size cannot be too large so that the DVFS scheduler is reactive to workload variation, but the window size cannot be too small either as it risks significant prediction error. Empirically, we set the window size to be 3 by default in ecod.

Because there will always exist some error in any workload prediction, we integrate a rectifying mechanism to monitor and control the global performance slowdown. The basic idea is to calculate the workload prediction error in each interval and make some correction in the future scheduling of frequencies to compensate for the prediction error. Initially, the performance bound δ equals a user-defined performance constraint Δ, e.g. 5%. During execution, if the predicted λ is larger than the measured λ, we increase the value of δ for the next interval and vice versa.

Consider an interval of T(f) in a program execution. Assume λ_{F} is the predicted workload characterization of the program in an interval. The actual measured workload characterization is denoted as λₘ. Let fₚ be the frequency based on λ_{P}, which is the frequency the program has been running on and let fₘ be the frequency based on λₘ, which is the frequency the program should have been running on.

The error in execution time over the interval is

$$ζ = T ( {f}_{p} ) - T ( {f}_{m} ) = {C}_{on} \cdot ( \frac{1}{{f}_{p}} - \frac{1}{{f}_{m}} ) \qquad ( 9 )$$

where Cₒᵤₜ can be measured directly for current interval. f_{g} is already known in the current interval and fₘ can be obtained after completing this interval via frequency scheduling, i.e., Eq. (10). To compensate for the prediction error, the performance constraint for next interval becomes

$$δ = Δ + \frac{ζ}{T ( f )}$$

where T(f) is the time for next interval, Δ is the standard performance constraint without compensation, and ζ is calculated via Eq. (9).

C. Frequency Scheduling and Emulation

Assuming that λ̅ is the predicted workload characterization for the current interval, then based on Eq. (5), the ideal frequency for the current interval is

$${f}^{*} = \frac{\overline{λ} \cdot {f}_{max}}{\overline{λ} + δ} \qquad ( 10 )$$

However, due to the physical constraints of the processor itself, the available frequencies in a real system are bounded.

Thus, f* needs to be calculated as

$${f}^{*} = max ( {f}_{min} , \frac{\overline{λ} \cdot {f}_{max}}{\overline{λ} + δ} )$$

Finally, the calculated frequency f* may not be directly supported on a real system. So, we apply the method proposed in (Hsu, C. and Feng, W., A power-aware run-time system for high-performance computing. In Proceedings of the ACM/IEEE Supercomputing 2005 (SC05), 2005.) to emulate the calculated frequency f*.

### D. The Eco Algorithm

Synthesizing the steps shown above, we design our eco algorithm. The pseudocode for the eco algorithm.

Hardware:

n frequencies f₁, . . . , fₙ

Parameters:

I: time-interval size
δ: performance bound
L: prediction window size

Algorithm:
Initialize the λ window
Repeat

1. Measure CPU stall cycles due to off-chip activities for current

interval^{C}^{_{off}}

2. Compute coefficient λ for current interval
$λ = \frac{{f}^{2} I - f {C}_{off}}{{f}^{2} I - f {C}_{off} + {f}_{max} {C}_{off}}$
3. Predict the workload for next interval for all λ in window [0, L]

λ̅ = average(λ)

4. Compute the desired frequency^{f*}

${f}^{*} = max ( {f}_{min} , \frac{\overline{λ} \cdot {f}_{max}}{\overline{λ} + δ} )$

5. Schedule next interval I at ^{f*}

Steps 1 and 2 encompass workload characterization. Step 3 is workload prediction, and Steps 4 and 5 deal with frequency scheduling and emulation.

III—Experimental Set-Up

Here we detail the experimental set-up for evaluating our eco algorithm, including hardware and software platform, power and energy measurement, and ecod implementation.

A. Experimental Platform

The hardware platform in our experiment included a four-node cluster for computing and an additional node for recording the power and energy consumption. Each compute node contained two dual-core AMD Opteron 2218 processors and 4-GB main memory. Each CPU core included one 128-KB split instruction and data L1 cache. Two cores on the same die shared one 1 MB of L2 cache. Each processor supported six power/performance modes, as shown in Table I. Finally, the nodes were interconnected with Gigabit Ethernet.

TABLE I
Power/Performance Modes for ICE Cluster Node

| Frequency (GHz) | Voltage (V) |
|---|---|
| 2.6 | 1.30 |
| 2.4 | 1.25 |
| 2.2 | 1.20 |
| 2.0 | 1.15 |
| 1.8 | 1.15 |
| 1.0 | 1.10 |

We ran Red Hat Linux (kernel version 2.6.18) on each compute node. The Linux kernel CPUFreq subsystem was used for controlling DVFS and PERFCTR for hardware counter monitoring. With respect to the benchmarks, we used the latest NAS Parallel Benchmarks (NPB3.2-MPI). We use mpich2 (version 1.0.6) to run the benchmarks.

B. Energy Measurement and Processing

We used the “Watts Up? PRO ES” power meter to measure the total system energy for each node. Energy values were recorded immediately before and after the benchmark runs. The difference of the two energy values is the energy consumed by the system when the benchmark ran. Since DVFS scheduling only affects the power consumption of the CPU, would be misleading to evaluate our eco algorithm based on the energy consumption of total system. So, in addition to reporting the total system energy, we also evaluate the effect of eco on CPU energy by applying a CPU power model used in (Hsu, C. and Feng, W., A power-aware run-time system for high-performance computing. In Proceedings of the ACM/IEEE Supercomputing 2005 (SC05), 2005.) to isolate the CPU energy from the total system energy.

C. The ecod Implementation

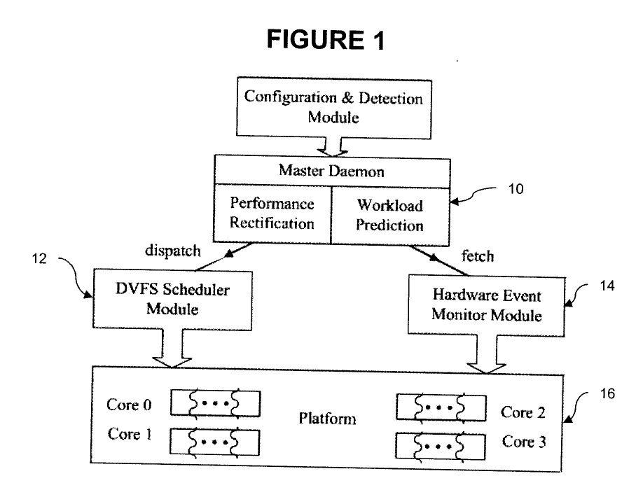

FIG. 1 illustrates the software architecture of our ecod implementation. We implemented ecod as a lightweight daemon that monitors all the cores in a node and schedules appropriate frequencies for them. When ecod starts up, it reads the configuration file and dynamically detects processor settings, e.g. available frequencies, number of cores, etc. In each sampling interval, the master daemon 10 fetches hardware-event information from the “Hardware Event Monitor Module” 14. Then, workload prediction and performance rectification are performed 10. In the end, the master daemon dispatches the desired frequency to “DVFS Scheduler Module” 12, which then takes care of frequency scheduling of the cores 16.

D. Parameters and Sensitivity Analysis

ecod is configurable and tunable. The configuration parameters as well as their default values for our experiments are shown in Table II.

TABLE II
Configuration Parameters and their Values in ecod

| Parameter | Description | Value |
|---|---|---|
| I | Sampling interval | 1 second |
| δ | performance bound | 5% |
| L | prediction window size | 3 |

The user-configurable parameters are sampling interval, performance bound, and prediction window size. Below are the tradeoffs of these user-configurable parameters.

Sampling Interval. As sampling intervals increase in length, the precision of workload characterization and its prediction will worsen, resulting in performance that cannot be tightly controlled. Conversely, when the sampling intervals get too short, the overhead of sampling the workload and scheduling the frequency is not as easily amortized.

Performance Bound. The larger the performance bound (or percentage slowdown), the more energy that will be saved. However, once the frequency reaches the system's lowest frequency, it cannot save any more energy.

Prediction Window Size. If the window size is large, the algorithm will depend on a larger amount of historical information, thus making more instantaneous workload prediction inaccurate. If the window size is small, the algorithm will be too sensitive to the workload variation.

In our experiments, we compare ecod with the β algorithm and the Linux on-demand governor. The performance constraint in the β algorithm is set to 5%. As for Linux on-demand governor, we use the default configuration with a sampling rate of 560,000 ms and up threshold of 80%.

### IV—Experiments and Analysis

In this section, we first validate the workload characterization λ obtained by measuring the CPU stall cycles due to off-chip activities against an off-line approach, described in Section V. Then, we evaluate the workload prediction method used in eco algorithm along with a sensitivity analysis of the algorithm. Finally, we demonstrate the efficacy of ecod, our power-aware daemon based on eco, on the NAS Parallel Benchmarks (NPB3.2-MPI) in a cluster environment.

A. Validation of Workload Characterization

Before evaluating eco on the NAS Parallel Benchmarks, we first validated our workload characterization (λ) on a representative set of 10 SPEC CPU2000 benchmarks: three CPU-bound, three memory-bound, and four in between. Specifically, by evaluating λ, we indirectly evaluate the measurement of CPU stall cycles due to off-chip activities.

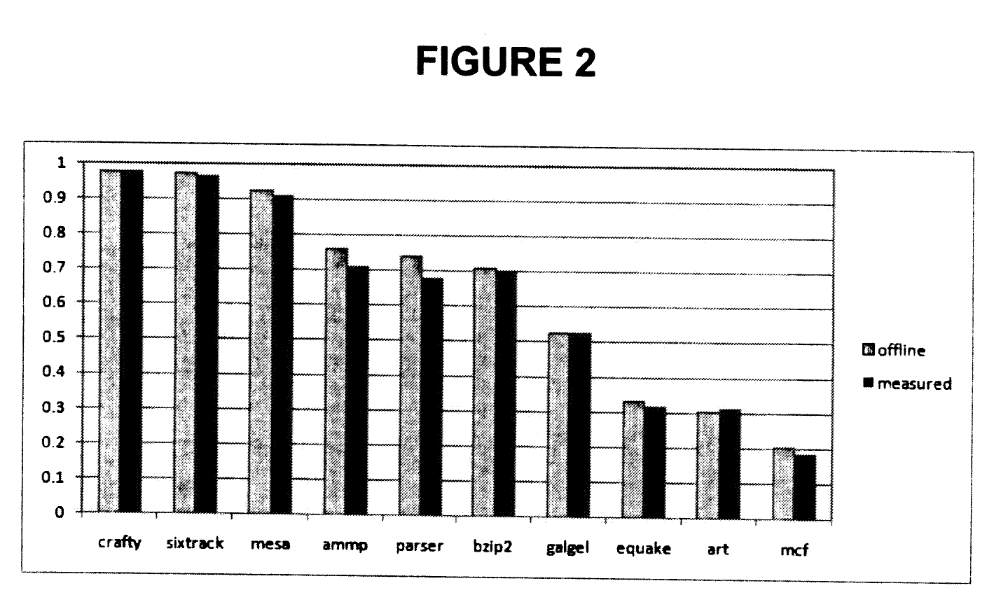

FIG. 2 shows our evaluation of measured λ to that of an off-line approach (see Section V below), with the benchmarks arranged in such a way that the CPU-boundedness (i.e., Y axis) of the benchmarks decrease going left to right. The error of the measured λ to off-line value is only 3.4% on average.

B. Evaluation of Workload Prediction

Here we use the workload characterization (λ) obtained by CPU stall cycles 25 due to off-chip activities as a baseline to evaluate the effectiveness of our workload prediction method. We chose crafty, mcf, and bzip2 SPEC CPU2000 to illustrate the predictive performance on CPU-bound, memory-bound, and in-between benchmarks, respectively.

Over the execution time of the benchmarks, we determined that the difference between measured λ and predicted λ is within 2%. The predicted λ also changes more smoothly than measured λ. This reflects the stability of our algorithm, which in turn, avoids significant DVFS scheduling overhead since the larger the frequency transition, the more overhead that is induced in DVFS scheduling.

C. Sensitivity Analysis of Performance Bound

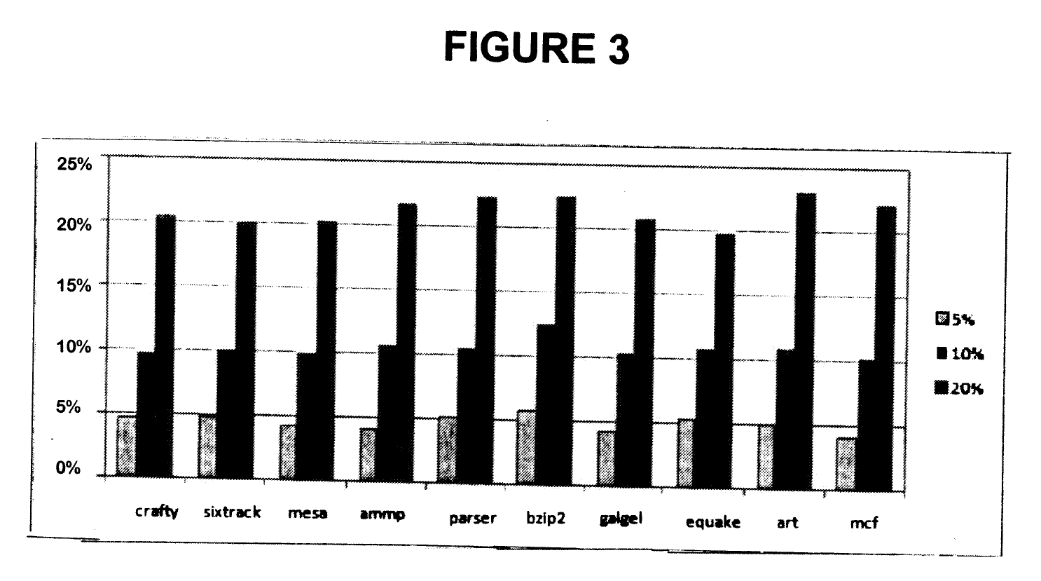

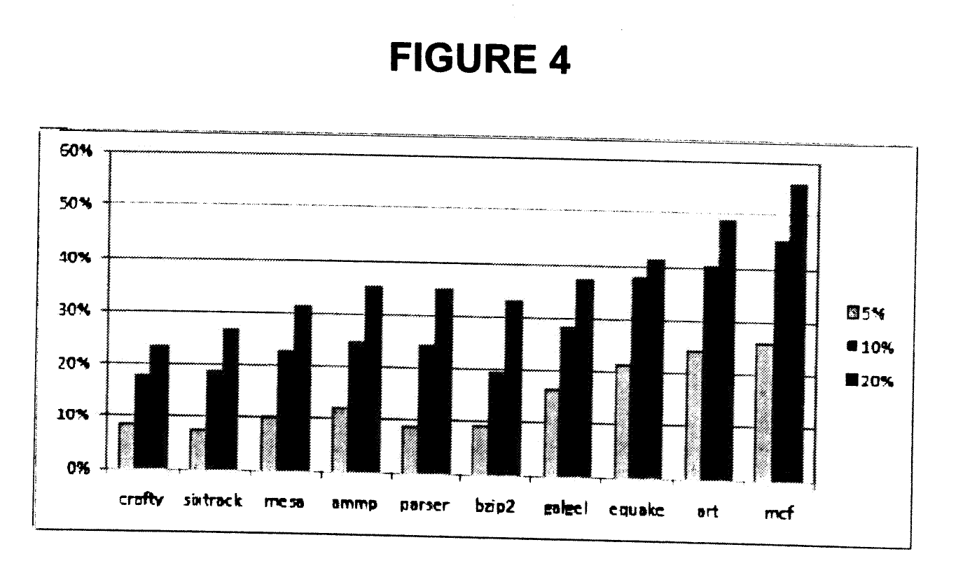

Since ecod can more tightly control performance loss, we also evaluate how ecod behaves with different performance bounds. FIG. 3 shows that ecod can bound the performance quite well; the performance variances for all the performance bounds are within 3%. FIG. 4 shows that while maintaining performance, ecod can also achieve up to 56% in energy savings.

D. Parallel Experiment

With the validation of our workload characterization and workload prediction, coupled with our sensitivity analysis, all on a per-node basis as shown above, we next evaluated our eco algorithm, implemented as an eco-friendly daemon that we call ecod in a cluster environment. In such an environment, we expect the performance of our eco-friendly daemon to be quite good given the additional opportunities for energy savings due to frequent memory and I/O access, network process synchronization, as well as CPU idling.

To evaluate ecod, we used the NAS Parallel Benchmarks. We ran the benchmarks with a Class C workload on 16 cores across four compute nodes, with each compute node containing four cores. Since the cores on the same die have a common power/performance mode, we scheduled the core frequency according to the higher one on the same die in order to guarantee performance.

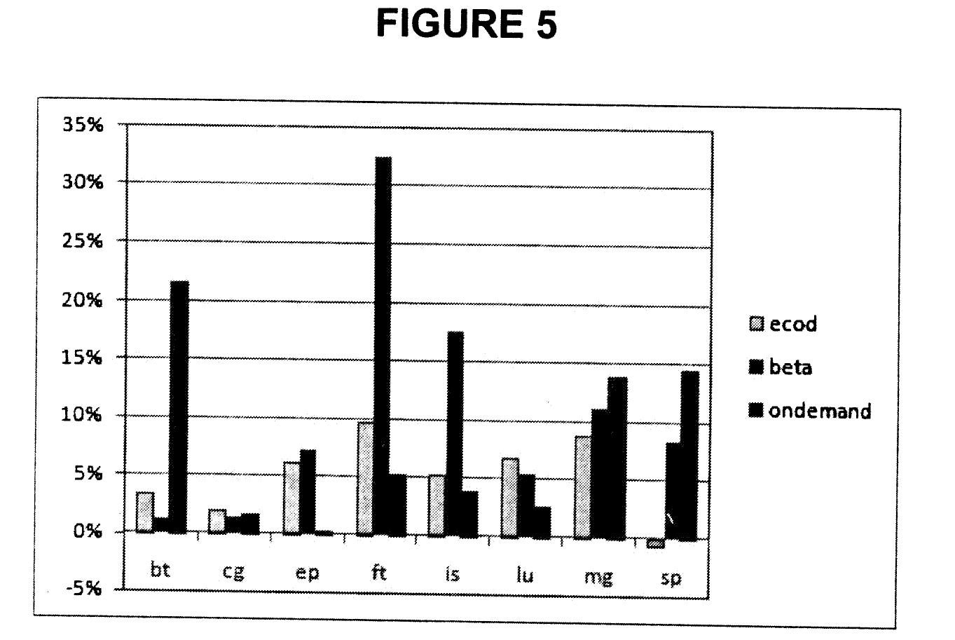

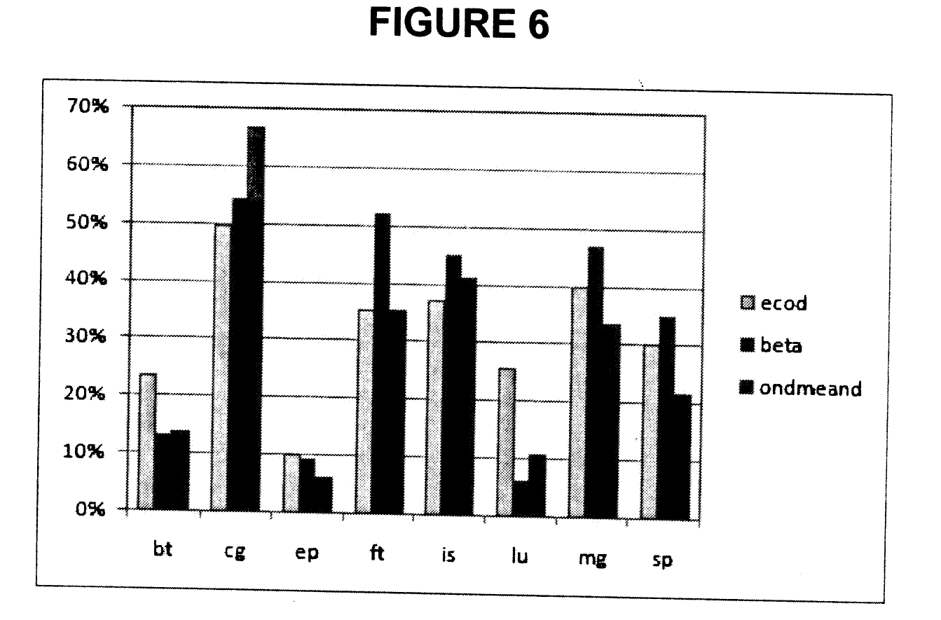

FIGS. 5 and 6 show the performance control and energy savings of ecod in comparison with the β algorithm and Linux on-demand governor, respectively. Table III summarizes the statistics on performance loss and energy savings. The performance loss averages 5.1%, which is better than the β algorithm (10.6%) and Linux on-demand governor (7.9%). The standard deviation of ecod is also the best among the three algorithms.

TABLE III
Statistics on Parallel Experiment

| | ecod | β | Linux on-demand |
|---|---|---|---|
| Performance Mean | 5.1% | 10.6% | 7.9% |
| Performance Standard Dev. | 3.5% | 10.3% | 7.7% |
| Energy Mean | 31.5% | 32.9% | 28.6% |

The CPU energy savings are comparable between ecod (average of 31.5%), β algorithm (average of 32.9%) and Linux on-demand governor (average of 28.6%). Considering that ecod achieves the same energy saving by sacrificing far less performance, ecod clearly performs better than the β algorithm and Linux on-demand governor.

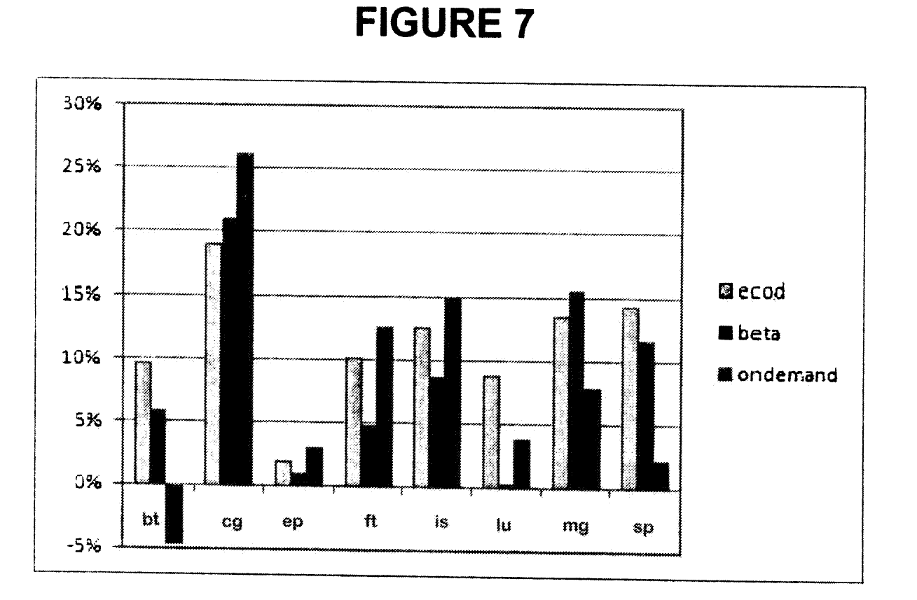

Finally, with respect to overall energy savings, ecod performs better than the β algorithm and the Linux on-demand governor on average, as shown in FIG. 7. ecod can achieve 11% energy savings on average across the NAS Parallel Benchmarks. Both 0 and the Linux on-demand governor have energy savings of 8% for the same benchmarks on average.

### V—Off-Line Measurement of Off-Chip Cycles

Here we describe an off-line method to calculate the CPU boundedness for an application and use it as a baseline to evaluate our measurement of CPU stall cycles due to off-chip activities. The method is described below.

1) run the application for each available CPU frequency and record the corresponding execution time.

2) normalize the execution time for each CPU frequency to the execution time at maximum CPU frequency fₘₐₓ.

3) draw a graph canvas in which X-axis is CPU cycle time and Y-axis is the execution time of the application.

4) draw points onto the canvas. X-coordinate of each point is the reverse of its running CPU frequency and Y coordinate of each point is the execution time on that CPU frequency.

5) take the point of maximum frequency as the fixed point of trend line and use linear least square regression method to determine the slope of the trend line. The slope will minimize the least-square error:

$$min {\sum }_{i = 1}^{n - 1} {‖ T ( {f}_{i} ) - k ( \frac{1}{{f}_{i}} - \frac{1}{{f}_{max}} ) - T ( {f}_{max} ) ‖}_{min}^{2}$$

6) the slope of the line is actually the CPU execution cycle Cₒₙ when the application is running at maximum frequency for 1 second. In other words, the slope is the average CPU execution cycles when running on maximum frequency.

7) use the equation (1) to calculate C_{off}.

8) use the equation (8) to calculate λ.

1. A method for optimizing computing efficiency in dynamic voltage and frequency scaled processors comprising the steps of:
determining off-chip stall cycles in a processor for a current interval by (i) measuring on-chip processor stall cycles due to off-chip activities and (ii) measuring off-chip processor stall cycles due to off-chip activities, and selecting the lowest value from amongst (i) and (ii);
characterizing application workloads in said processor for said current interval independent of computing frequency at which an application is running, said characterizing step using said off-chip stall cycles determined in said determining step;
predict application workload for a next interval using an average of application workloads for the current interval and one or more previous intervals;
compute a desired frequency for said next interval using said predicted application workload and the specified performance bound; and
schedule the frequency of the next interval to be the computed desired frequency.

2. The method of claim 1 wherein measuring on-chip processor stall cycles due to off-chip activities measures the sum of the processor's decoder stall cycles due to branch misprediction and full reorder buffer.

3. The method of claim 1 wherein measuring off-chip processor stall cycles due to off-chip activities includes measurement of off-chip memory accesses, memory access latency, and processor stall time waiting for input/output completion.

4. The method of claim 1 further comprising the step of repeating said determining, characterizing, predicting, computing, and scheduling steps multiple times while said processor is operating.

5. The method of claim 1 further comprising the step of adjusting a performance bound based on said prediction application workload.

6. The method of claim 1 wherein said current interval is approximately 1 second.

7. The method of claim 1 further comprising the step of adjusting one or more of a sampling interval, a performance bound, and a prediction window size.

8. The method of claim 1 wherein said step of scheduling the frequency for the next interval includes the step of emulating the computed desired frequency if the processor does not support the frequency.

9. A computer system with one or more dynamic voltage and frequency scaled processors comprising:
means for determining off-chip stall cycles in a processor for a current interval by (i) measuring on-chip processor stall cycles due to off-chip activities and (ii) measuring off-chip processor stall cycles due to off-chip activities, and selecting the lowest value from amongst (i) and (ii);
means for characterizing application workloads in said processor for said current interval independent of computing frequency at which an application is running, said means for characterizing using said off-chip stall cycles determined in said determining step;
means to predict application workload for a next interval using an average of application workloads for the current interval and one or more previous intervals;
means to compute a desired frequency for said next interval using said predicted application workload and the specified performance bound; and
means to schedule the frequency of the next interval to be the computed desired frequency.
